(19) United States
(12) Patent Application Publication
(10) Pub. No.: US 2018/0308030 A1
(43) Pub. Date: Oct. 25, 2018

(54) System and Method for Establishing Regional Distribution Center Inventory Levels for New Third Party Products

(71) Applicant: Walmart Apollo, LLC, Bentonville, AR (US)

(72) Inventors: Behzad Nemati, Springdale, AR (US); Ehsan Nazarian, Rogers, AR (US)

(73) Assignee: Walmart Apollo, LLC, Bentonville, AR (US)

(21) Appl. No.: 15/960,684

(22) Filed: Apr. 24, 2018

Related U.S. Application Data
(60) Provisional application No. 62/489,110, filed on Apr. 24, 2017.

(51) Int. Cl. G06Q 10/06; G06Q 30/02; G06N 99/00

(52) U.S. Cl. CPC G06Q 10/06315; G06N 99/005; G06Q 10/06314; G06Q 30/0202

(57) ABSTRACT

Systems, methods, and computer-readable storage media for using historical data associated with related products, current inventory levels, and machine learning, to predict the amount of inventory for a new product (which a retailer has not previously sold) multiple retail locations require. Data regarding actual sales of the new product is then saved and used to update the machine learning model, such that the next time a new product is released, an improved algorithm for predicting the demand is used.

### BACKGROUND

### 1. Technical Field

The present disclosure relates to an inventory control system, and more specifically to using machine learning to estimate demand for a new product.

### 2. Introduction

Product distribution systems often follow a model where third party provider of a product delivers a finished product to a distribution center for a retailer, then the retailer transports the product from the distribution center to nearby retail locations. For example, a third party provider of toothpaste (such as the manufacturer or an intermediary) who has contracted with a retailer to sell the toothpaste in retail stores will deliver a truckload of toothpaste product to a distribution center associated with the retailer. The retailer will then send trucks from the distribution center to retail locations for sale to customers, each truck having some toothpaste as well as other products. However, this system requires the retailer to predict demand for the product and stock product inventory accordingly, and when new products are introduced no historical data specific to the new product is available to predict demand.

### SUMMARY

A method which practices the concepts disclosed herein may include: receiving, at a server, instructions to predict demand across a plurality of retail stores for a new product which has not been previously sold within the plurality of retail stores; generating, via a processor of the server, a similarity measurement between the new product and previously sold items, wherein the similarity measurement compares attributes of the new product to the previously sold items, and wherein the similarity measurement is generated by: identifying a sales category for the new product; identifying attributes of the new product; identifying replacement items for the new product; and comparing the attributes of the new product to the attributes of the previously sold items, and the replacement items within the sales category, to yield the similarity measurement; based on the similarity measurement, making a data request to a historical sales database for sales information associated with the previously sold items; receiving the sales information associated with the previously sold items from the historical sales database; calculating, based on the sales information and the similarity measurement, a predicted demand for the new product; receiving a supply availability of the new product; and generating an inventory distribution schedule of the new product for the plurality of retail stores based on the supply availability and the predicted demand.

A system configured to practice concepts as disclosed herein may include: a processor; and a computer-readable storage medium having instructions stored which, when executed by the processor, cause the processor to perform operations comprising: receiving instructions to predict demand across a plurality of retail stores for a new product which has not been previously sold within the plurality of retail stores; generating a similarity measurement between the new product and previously sold items, wherein the similarity measurement compares attributes of the new product to the previously sold items, and wherein the similarity measurement is generated by: identifying a sales category for the new product; identifying attributes of the new product; identifying replacement items for the new product; and comparing the attributes of the new product to the attributes of the previously sold items, and the replacement items within the sales category, to yield the similarity measurement; based on the similarity measurement, making a data request to a historical sales database for sales information associated with the previously sold items; receiving the sales information associated with the previously sold items from the historical sales database; retrieving, from a database, a first version of a machine learning forecast; calculating, based on the sales information and the similarity measurement, a predicted demand for the new product, wherein the calculating of the predicted demand comprises: entering inputs into the first version of the machine learning forecast, the inputs comprising the sales information and the similarity measurement; and receiving from the first version of the machine learning forecast, the predicted demand, wherein the first version of the machine learning forecast uses a weighted calculation of the sales information and the similarity measurement to generate the predicted demand; receiving a supply availability of the new product; generating an inventory distribution schedule of the new product for the plurality of retail stores based on the supply availability and the predicted demand; recording actual sales data in the historical sales database; and generating an updated version of the machine learning forecast based on the actual sales data.

A non-transitory computer-readable storage medium configured according to the concepts the concepts disclosed herein may cause a computing device to perform operations including: receiving instructions to predict demand across a plurality of retail stores for a new product which has not been previously sold within the plurality of retail stores; generating a similarity measurement between the new product and previously sold items, wherein the similarity measurement compares attributes of the new product to the previously sold items, and wherein the similarity measurement is generated by: identifying a sales category for the new product; identifying attributes of the new product; identifying replacement items for the new product; and comparing the attributes of the new product to the attributes of the previously sold items, and the replacement items within the sales category, to yield the similarity measurement; based on the similarity measurement, making a data request to a historical sales database for sales information associated with the previously sold items; receiving the sales information associated with the previously sold items from the historical sales database; calculating, based on the sales information and the similarity measurement, a predicted demand for the new product; receiving a supply availability of the new product; and generating an inventory distribution schedule of the new product for the plurality of retail stores based on the supply availability and the predicted demand.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

### BRIEF DESCRIPTION OF THE DRAWINGS

FIG. 1 illustrates an exemplary distribution system;

FIG. 2 illustrates an exemplary flowchart for predicting inventory levels using machine learning;

FIG. 3 illustrates an exemplary method embodiment; and

FIG. 4 illustrates an exemplary computer system which can be used to practice the concepts disclosed herein.

### DETAILED DESCRIPTION

When a third party makes the decision to begin selling a new product in retail stores, the retailer makes determinations regarding how much of the new product to inventory in each retail location. Purchasing/carrying too few of the new product results in missed opportunities to make sales. Likewise, purchasing too many of the new product will result in excess inventory, again resulting in a loss to the retailer.

Systems configured according to this disclosure use historical data associated with related products, current inventory levels, and machine learning, to predict the amount of inventory for the new product which each retail location requires. Data regarding actual sales of the new product is then saved and used to update the machine learning model, such that the next time a new product is released, an improved algorithm for predicting the demand is used.

Consider the following example. A manufacturer of cereal has determined to introduce a new cereal in grocery stores, and contracted with a grocery store retailer to do so. Because the retailer has not sold this particular cereal before, it does not know how much to order or what the demand for the cereal will be. By using a system as disclosed herein, the retailer can make a prediction for the demand of the cereal, and based on the results will be able to have improved prediction for the next new product introduced to the retailer's stores.

The retailer's system to predict the demand for the new product uses attributes of the new product to determine similarity between the new product and previously sold products. This similarity is determined using a similarity index, where attributes of products are stored and compared against one another. In one configuration, the similarity index can take the form of a table, where attributes of each and every product sold by the retailer are recorded. Exemplary attributes of a product can include the weight, volume, material, color, brand, product category, number of non-retail units contained within the product, calorie count, etc. For any particular product, the attributes of the product are static, as compared to other data (sales data, marketing data, location within a store, etc.) which may vary over time. When new versions of the product (i.e., new label, new configuration, new quantity, etc.) are released, the retailer can either revise the information associated with the product or, preferably, augment the similarity index with new or updated information.

Attributes for an item can be entered into the system via manual entry. For example, a human operator can manually type or otherwise enter the attributes into a computer-based storage system containing the similarity index. Alternatively, a three-dimensional scanner can be used to record scan the item, then send the item attributes to a server or database storing the similarity index. The three-dimensional scanner can, for example, record information about the shape, color, weight, etc., of the item.

The system then uses the similarity index to compare the new item to previous items, and can develop a similarity prediction based on how the new product relates to those previous items. Attributes of the new product may be associated with the attributes in the table. In some configurations, this similarity prediction is the result of a weighted equation. For example, comparing a wooden chair to a candy bar using the similarity index could result in a similarity score which is computed: similarity score=0.2*color difference+0.2*brand difference+0.2*size difference+0.4*product type difference. Because a chair and a candy bar are likely to have large distinctions in brand, size, and product types, the similarity score in this example will be quite large (indicating that the products are not similar). By contrast, a similar comparison of two types of candy bars is likely to result in smaller distinctions, and therefore a smaller similarity score will result (indicating that the products are more similar) should the same weighted equation (or a similar equation) be used to determine similarity of a product to other products. Alternatively, the similarity score can be a weighted equation, where data (such as historical sales data) from similar products can be input into the equation based on the similarity.

Using the similarity score and/or the similarity index, the historical performance/demand of other products can be used to predict what the future demand for the new product will be. For example, the system retrieves the historical sales data for the top two products which are most similar to the new product based on the similarity score. The system can then use the historical sales data of those two similar products in forming a prediction of the demand for the new product. In other configurations, the system can use the similarity score to obtain distinct amounts of data. For example, in some configurations, the system can select only the historical data associated with the most-similar product previously sold in making the demand prediction. In other configurations, the system can collect the historical data associated with any products above a threshold similarity (i.e., if the system computes that the new product and the previously sold product are 75% similar, it will use the historical sales data of the previously sold product in making demand predictions, regardless of how many other previously sold products are also above the 75% threshold). In yet other configurations, the system can weight historical sales data based on the level of similarity.

The predicted demand can also be based on customer orders (for online sales) and in-store purchases of related products, as determined by the similarity index. To support this, systems configured according to this disclosure can receive real-time notifications of sales or orders of the related products. Likewise, the predicted demand can be based on the amount of inventory of products which will compete with, or replace, the new product (i.e., replacement products). For example, the system can receive a real-time inventory amount in the form of an electronic signal sent from a store-specific server, the electronic signal conveying (1) the product identification for the product sold, and (2) the store's current inventory of the product sold. In some configurations, the current inventory can be further analyzed in view of the percentage of current inventory available.

Other factors which can be used to predict the demand for the new product at a retail location can be calendar events (weekdays versus weekends, holidays, etc.), marketing/advertising, response times to new products for customers in a particular region, national/regional distribution (if, for example, the product has already been introduced in major markets, there may be increased demand for it in a rural location when it is introduced), online reviews, newspaper reviews, magazine reviews, and the distribution of samples to key individuals in a community.

The system then employs modeling to predict the amount of the new product which is needed at a given location within the retailer network. In some cases, this prediction can be made using time series and regression modeling based on the historical data of other products based on the similarity value. In other configurations, the prediction can be made using a machine learning algorithm. After each prediction is made via the machine learning algorithm, the algorithm can be updated based on actual sales of the new product. When subsequent new products are introduced, the upgraded/improved machine learning algorithm can be used to make the demand prediction. In yet other configurations, time series and regression modeling using the historical data of other products can be performed in parallel with machine learning. The results of this parallel processing can then be either the model which has the best record of accurate predictions, or can be a combination of the machine learning prediction and the time series and regression modeling prediction. Making predictions in this manner can help reduce the noise and uncertainty inherent in predicting demand for a new product.

In some configurations, the iterative updates to the machine learning algorithm are tailored based on distinct aspects of the data being received. For example, in some configurations, the timeframe for which data is available, as well as the seasonality of the data (i.e., how often certain patterns appear in the data, such as weekly, monthly, quarterly, annually), are used to define sets of data and train the machine learning algorithm. In a preferred configuration, the sets used to train the algorithm represent both a good portion of the overall data as well as the seasonality of the data. For example, if the system has three years of data with an annual seasonality/pattern, the system can use two years as a training set and one year as a testing set, whereas if the three years of data had a monthly seasonality/pattern, the system could use 32 months as training data and four months as a testing set. The seasonality in the data can also contribute to the frequency of the iterative updates. Fast changing items and categories would require more frequent updates compared to more stable items and categories. Each iteration would bring in, for example, newly added historical data, and from that newly added historical data, the machine learning algorithm can provide updated forecasts of demand.

By using this iterative machine learning, the supply chain can become more efficient and robust, and the supply chain can adapt to changing demands, supply, etc. In determining the amount of the product to be stored at distribution centers and retail locations, the system can treat the entire network as the source of the product, rather than a single store or distribution center as the source. In other words, some configurations can rely on total system inventory availability when making the prediction rather than the inventory available at a nearby distribution center. In addition, such predictions can rely on percentages, such as the percentage of capacity currently filled by other inventory items or the availability of replacement items (those items which a customer could purchase instead of the new product).

In some configurations, the third party can be a third party e-commerce supplier with a web/e-commerce website. The third party sells items through the web/e-commerce website and contracts with a retailer to sell merchandise in brick and mortar stores. In other circumstances, the third party can have their own retail locations, but use a retailer for providing in-store merchandise in other locations. In some cases, these boundaries can identify specific geographic areas, such as cities/states which are serviced by the third party or a distinct retailer. The retail locations and the distribution centers can be further defined based on the geography, such that a given distribution center services retail locations within a predefined distance of the distribution center. The overall demand for the region (i.e., the sum of the demand across multiple retail locations) can be used to identify the amount of inventory which needs to be delivered to the distribution center which services that region, thereby making certain that each store in the region can have the number of items needed. Determining the amount of items to deliver can be based on historical data for a specific item, or on the historical data of similar items, using the similarity index disclosed herein.

The concepts disclosed herein can also be used to improve the computing systems which are performing, or enabling the performance, of the disclosed concepts. For example, information associated with routes, deliveries, truck cargo, distribution center inventory or requirements, retail location inventory or requirements, etc., can be generated by local computing devices. In a standard computing system, the information will then be forwarded to a central computing system from the local computing devices. However, systems configured according to this disclosure can improve upon this “centralized” approach.

One way in which systems configured as disclosed herein can improve upon the centralized approach is combining the data from the respective local computing devices prior to communicating the information from the local computing devices to the central computing system. For example, a truck traveling from a distribution center to a retail location may be required to generate information about (1) the route being travelled, (2) space available in the truck for additional goods, (3) conditions within the truck, etc. Rather than transmitting each individual piece of data each time new data is generated, the truck processor can cache the generated data for a period of time and combine the generated data with any additional data which is generated within the period of time. This withholding and combining of data can conserve bandwidth due to the reduced number of transmissions, can save power due to the reduced number of transmissions, and can increase accuracy due to holding/verifying the data for a period of time prior to transmission.

Another way in which systems configured as disclosed herein can improve upon the centralized approach is adapting a decentralized approach, where data is shared among all the individual nodes/computing devices of the network, and the individual computing devices perform calculations and determinations as required. In such a configuration, the same truck described above can be in communication with the retail location and the distribution center, and can make changes to the route, destination, pickups/deliveries, etc., based on data received and processed while enroute between locations. Such a configuration may be more power and/or bandwidth intensive than a centralized approach, but can result in a more dynamic system because of the ability to modify assignments and requirements immediately upon making that determination. In addition, such a system can be more secure, because there are multiple points of failure (rather than a single point of failure in a centralized system).

It is worth noting that a “hybrid” system might be more suitable for some specific configurations. In this approach, a part of the network/system would be using the centralized approach (which can take advantage of the bandwidth savings described above), while the rest of the system is utilizing a de-centralized approach (which can take advantage of the flexibility/increased security described above). For instance, the trucks could be connected to a central server at the distribution center, while that server is connected to a decentralized network of store computers.

Having provided a broad description of the concepts of this invention, the disclosure now provides description of the specific embodiments shown in the illustrations. While specific implementations are described, it should be understood that this is done for illustration purposes only. Other components and configurations may be used without parting from the spirit and scope of the disclosure.

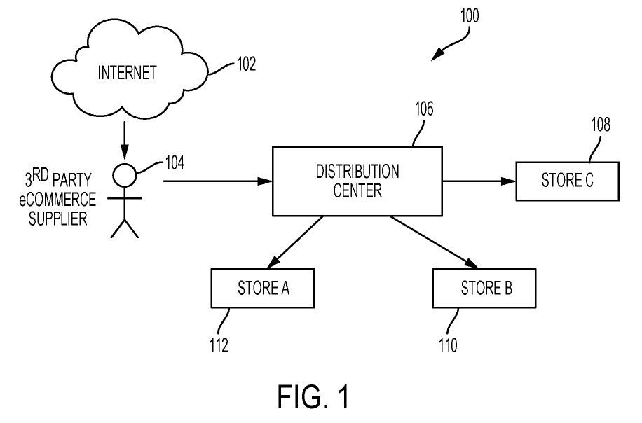

FIG. 1 illustrates an exemplary distribution system 100. In this example 100, a third party e-commerce supplier 104 receives and processes orders from the Internet 102. In other configurations, the third party supplier 104 may not be exclusively an e-commerce supplier 104, but may be arranging with a retailer to sell a product (or products) in the retailer's stores 108-112. To get the product(s) to the retail stores 108-112, the third party e-commerce supplier 104 arranges for the product(s) to be delivered directly to a distribution center 106 associated with the retailer or can deliver the product to the retail location. The retailer then transports the product(s) from the distribution center 106 to the individual retail stores 108-112. However, in the case of a new product, the retailer determines how much to distribute to each location 106-112. That is, the retailer determines how to distribute to each of the retail locations 108-112, and also determines how much to keep in inventory (if any) at the distribution center 106.

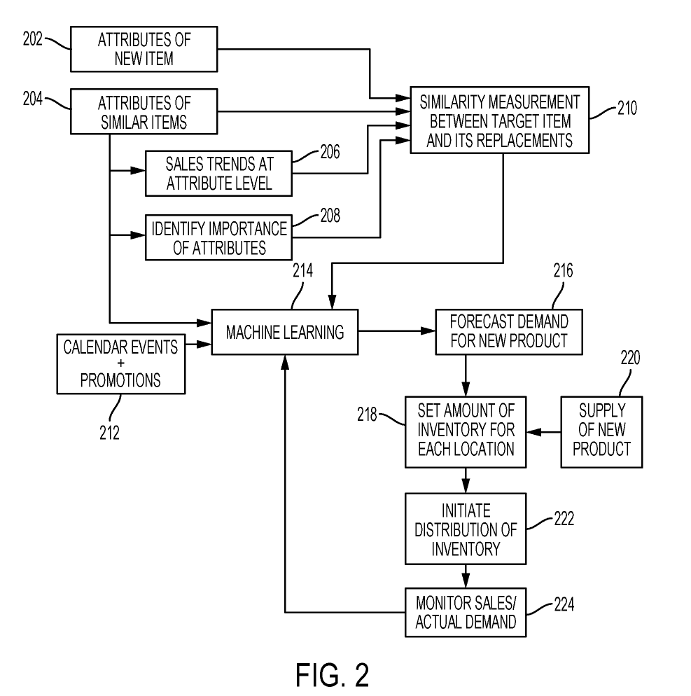

FIG. 2 illustrates an exemplary flowchart for predicting inventory levels using machine learning. In this example, attributes of a new item 202 are entered into a system (such as a server configured to perform machine learning). These attributes 202 can, for example, be obtained through the use of three dimensional scanning, manual entry, or other mechanisms. The system obtains attributes of items similar 204 to the new product, as well as sales trends based on those attributes 206 and the relative importance of those attributes 208 in sales. The current attributes may also be associated with the stored attributes and matches identified. This data 204, 206, 208 regarding similar products is combined with the data regarding the new product attributes 202, to yield a similarity measurement between the target (new) item and possible replacement items 210.

Based on the similarity measurement, the system conducts machine learning 214 using, for example, the attributes of the similar items 204 (which can include the sales trends 306 and relative importance of attributes 208 of those items), as well as information such as calendar events, holidays, marketing/advertising information/promotions, 212, etc. In addition, the inputs can further include the attributes of the new item 202. The machine learning algorithm 214 generates a forecast demand for the new product 216, which allows the system to set an amount of inventory for each location 218. In determining how much inventory to store at each location, the system can further rely upon the total supply of the new product available 220.

The system then initiates the initial distribution of the product to the distribution centers and retail locations 222 based on the based on the previous determinations. The system monitors the sales (i.e., the actual demand of the new product) and uses those sales numbers to modify the machine learning algorithm 214. Thus, with each iteration, the machine learning algorithm 214 is updated based on a comparison of the predicted demand and the actual sales of the new item.

It is noted that the exemplary flowchart illustrated in FIG. 2 can be modified as required for specific configurations. For example, individual steps may be added or removed, or different components used in making determinations than illustrated.

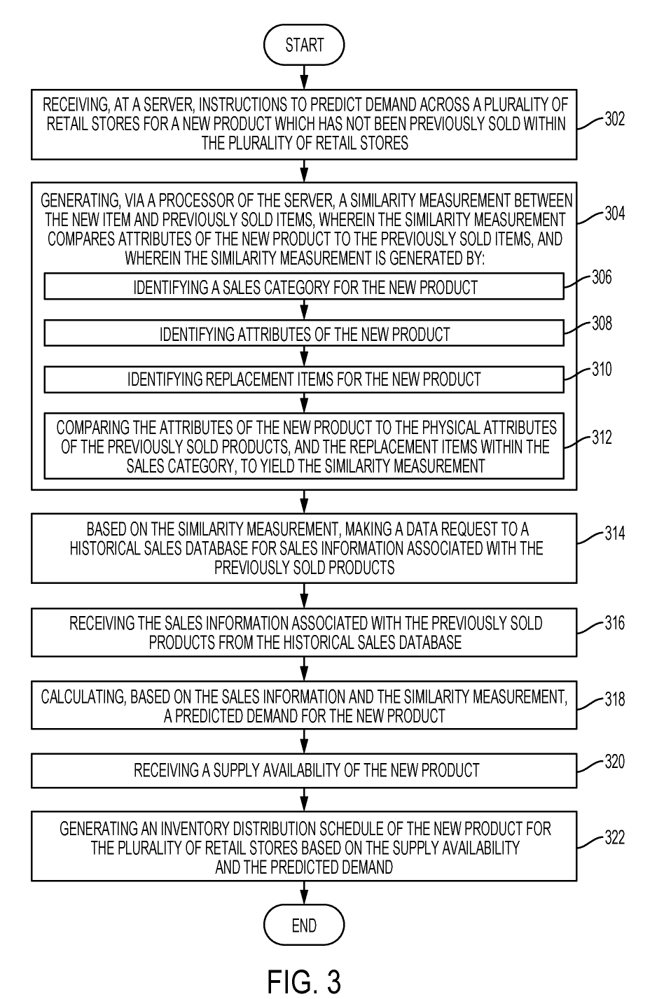

FIG. 3 illustrates an exemplary method embodiment. The steps outlined herein are exemplary and can be implemented in any combination thereof, including combinations that exclude, add, or modify certain steps. For purposes of explanation, the method of FIG. 3 is being performed by a server or other computing device configured to receive real-time inventory information simultaneously from multiple retail locations while, in parallel, calculating demand for a new product.

In this example, the system receives, at the server, instructions to predict demand across a plurality of retail stores for a new product which has not been previously sold within the plurality of retail stores (302). For example, this new product may be a product supplied by a third party, e-commerce supplier. The server generates, via a processor, a similarity measurement between the new item and previously sold items, wherein the similarity measurement compares attributes of the new product to the attributes of previously sold items, and wherein the similarity measurement is generated by (304): identifying a sales category for the new product (306), identifying attributes of the new product (308), identifying replacement items for the new product (310), and comparing the attributes of the new product to the physical attributes of the previously sold products, and the replacement items within the sales category, to yield the similarity measurement (312).

Based on the similarity measurement, the server makes a data request to a historical sales database for sales information associated with the previously sold products (314) and receives the sales information associated with the previously sold products from the historical sales database (316). The server then calculates, based on the sales information and the similarity measurement, a predicted demand for the new product (318). The server can receive a supply availability of the new product (320). This information can be received, for example, from the supplier of the new product. The server then generates an inventory distribution schedule of the new product for the plurality of retail stores based on the supply availability and the predicted demand (322). The inventory distribution schedule identifies how much of the new product needs to be transported to each of the retailer locations (such as a distribution center or a retail location), as well as when the shipments will take place.

Exemplary attributes, both of the new product and of the previously sold products, can include a shape, a color, a weight, a brand, an amount, and a quality of the respective items. Such attributes can be manually identified and entered by a human being, or preferably can be identified (at least partially) using a three-dimensional scanner or model of the respective product.

In some configurations, the method illustrated in FIG. 3 can be augmented to further include retrieving, from a database, a first version of a machine learning forecast; entering, as part of the calculating of the predicted demand, inputs into the first version of the machine learning forecast, the inputs comprising the sales information and the similarity measurement; receiving, as part of the calculating of the predicted demand, from the first version of the machine learning forecast, the predicted demand, wherein the first version of the machine learning forecast uses a weighted calculation of the sales information and the similarity measurement to generate the predicted demand; receiving actual sales data associated with the new product; recording the actual sales data in the historical sales database; and generating an updated version of the machine learning forecast based on the actual sales data. In such configurations, the inputs into the first version of the machine learning forecast can further include promotions and/or calendar events associated with the new product.

In yet other configurations, the method can further include generating a distribution center inventory distribution schedule of the new product for distribution centers which service the plurality of retail stores, the distribution center inventory distribution schedule being based on the supply availability and the predicted demand. In such configurations, the inventory distribution schedule and the distribution center inventory distribution schedule can be further based on current inventory levels of the replacement items for the new product within the plurality of retail stores and the distribution centers. Such inventory levels can be, for example, received by the server in real-time each time a sale of one of those replacement items is made, or on a periodic basis.

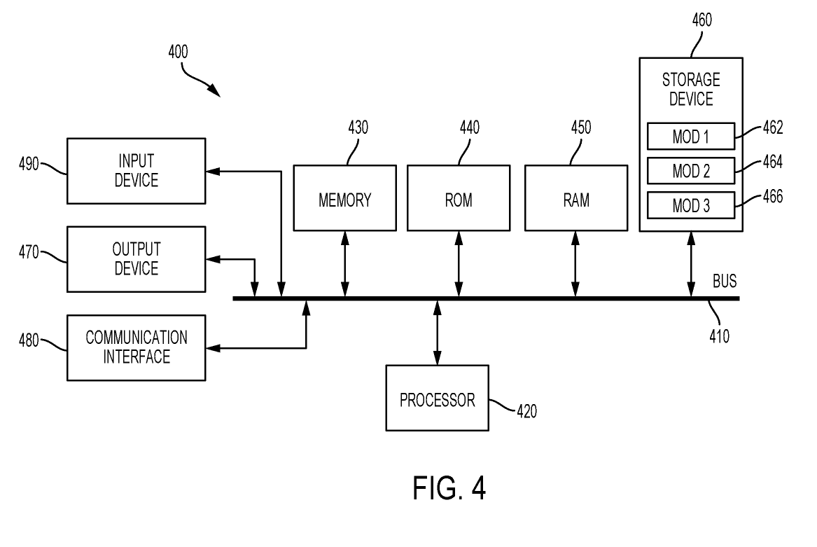

FIG. 4 illustrates an exemplary computer system which can be used to practice the concepts disclosed herein. More specifically, FIG. 4 illustrates a general-purpose computing device 400, including a processing unit (CPU or processor) 420 and a system bus 410 that couples various system components including the system memory 430 such as read only memory (ROM) 440 and random access memory (RAM) 450 to the processor 420. The system 400 can include a cache of high speed memory connected directly with, in close proximity to, or integrated as part of the processor 420. The system 400 copies data from the memory 430 and/or the storage device 460 to the cache for quick access by the processor 420. In this way, the cache provides a performance boost that avoids processor 420 delays while waiting for data. These and other modules can control or be configured to control the processor 420 to perform various actions. Other system memory 430 may be available for use as well. The memory 430 can include multiple different types of memory with different performance characteristics. It can be appreciated that the disclosure may operate on a computing device 400 with more than one processor 420 or on a group or cluster of computing devices networked together to provide greater processing capability. The processor 420 can include any general purpose processor and a hardware module or software module, such as module 1 462, module 2 464, and module 3 466 stored in storage device 460, configured to control the processor 420 as well as a special-purpose processor where software instructions are incorporated into the actual processor design. The processor 420 may essentially be a completely self-contained computing system, containing multiple cores or processors, a bus, memory controller, cache, etc. A multi-core processor may be symmetric or asymmetric.

The system bus 410 may be any of several types of bus structures including a memory bus or memory controller, a peripheral bus, and a local bus using any of a variety of bus architectures. A basic input/output (BIOS) stored in ROM 440 or the like, may provide the basic routine that helps to transfer information between elements within the computing device 400, such as during start-up. The computing device 400 further includes storage devices 460 such as a hard disk drive, a magnetic disk drive, an optical disk drive, tape drive or the like. The storage device 460 can include software modules 462, 464, 466 for controlling the processor 420. Other hardware or software modules are contemplated. The storage device 460 is connected to the system bus 410 by a drive interface. The drives and the associated computer-readable storage media provide nonvolatile storage of computer-readable instructions, data structures, program modules and other data for the computing device 400. In one aspect, a hardware module that performs a particular function includes the software component stored in a tangible computer-readable storage medium in connection with the necessary hardware components, such as the processor 420, bus 410, display 470, and so forth, to carry out the function. In another aspect, the system can use a processor and computer-readable storage medium to store instructions which, when executed by the processor, cause the processor to perform a method or other specific actions. The basic components and appropriate variations are contemplated depending on the type of device, such as whether the device 400 is a small, handheld computing device, a desktop computer, or a computer server.

Although the exemplary embodiment described herein employs the hard disk 460, other types of computer-readable media which can store data that are accessible by a computer, such as magnetic cassettes, flash memory cards, digital versatile disks, cartridges, random access memories (RAMs) 450, and read only memory (ROM) 440, may also be used in the exemplary operating environment. Tangible computer-readable storage media, computer-readable storage devices, or computer-readable memory devices, expressly exclude media such as transitory waves, energy, carrier signals, electromagnetic waves, and signals per se.

To enable user interaction with the computing device 400, an input device 490 represents any number of input mechanisms, such as a microphone for speech, a touch-sensitive screen for gesture or graphical input, keyboard, mouse, motion input, speech and so forth. An output device 470 can also be one or more of a number of output mechanisms known to those of skill in the art. In some instances, multimodal systems enable a user to provide multiple types of input to communicate with the computing device 400. The communications interface 480 generally governs and manages the user input and system output. There is no restriction on operating on any particular hardware arrangement and therefore the basic features here may easily be substituted for improved hardware or firmware arrangements as they are developed.

The various embodiments described above are provided by way of illustration only and should not be construed to limit the scope of the disclosure. Various modifications and changes may be made to the principles described herein without following the example embodiments and applications illustrated and described herein, and without departing from the spirit and scope of the disclosure.

We claim:

1. A method comprising:
receiving, at a server, instructions to predict demand across a plurality of retail stores for a product which has not been previously sold within the plurality of retail stores;
generating, via a processor of the server, a similarity measurement between the new product and previously sold items, wherein the similarity measurement compares attributes of the new product to the previously sold items, and wherein the similarity measurement is generated by:
identifying a sales category for the new product;
identifying attributes of the product;
identifying replacement items for the product; and
comparing the attributes of the product to the attributes of the previously sold items, and the replacement items within the sales category, to yield the similarity measurement;
based on the similarity measurement, making a data request to a historical sales database for sales information associated with the previously sold items;
receiving the sales information associated with the previously sold items from the historical sales database;
calculating, based on the sales information and the similarity measurement, a predicted demand for the new product;
receiving a supply availability of the product; and
generating an inventory distribution schedule of the product for the plurality of retail stores based on the supply availability and the predicted demand.

2. The method of claim 1, wherein the attributes comprise:
a shape, a color, a weight, a brand, an amount, and a quality.

3. The method of claim 2, wherein the attributes are identified, at least in part, using a three-dimensional model of the product.

4. The method of claim 1, further comprising:
retrieving, from a database, a first version of a machine learning forecast;
entering, as part of the calculating of the predicted demand, inputs into the first version of the machine learning forecast, the inputs comprising the sales information and the similarity measurement
receiving, as part of the calculating of the predicted demand, from the first version of the machine learning forecast, the predicted demand, wherein the first version of the machine learning forecast uses a weighted calculation of the sales information and the similarity measurement to generate the predicted demand;
receiving actual sales data associated with the product;
recording the actual sales data in the historical sales database; and
generating an updated version of the machine learning forecast based on the actual sales data.

5. The method of claim 4, wherein the inputs into the first version of the machine learning forecast further comprise promotions and calendar events.

6. The method of claim 1, further comprising:
generating a distribution center inventory distribution schedule of the product for distribution centers which service the plurality of retail stores, the distribution center inventory distribution schedule being based on the supply availability and the predicted demand.

7. The method of claim 6, wherein the inventory distribution schedule and the distribution center inventory distribution schedule are further based on current inventory levels of the replacement items for the product within the plurality of retail stores and the distribution centers.

8. The method of claim 1, wherein the product is supplied by a third party e-commerce supplier.

9. A system comprising:
a processor; and
a computer-readable storage medium having instructions stored which, when executed by the processor, cause the processor to perform operations comprising:
receiving instructions to predict demand across a plurality of retail stores for a new product which has not been previously sold within the plurality of retail stores;
generating a similarity measurement between the new product and previously sold items, wherein the similarity measurement compares attributes of the new product to the previously sold items, and wherein the similarity measurement is generated by:
identifying a sales category for the new product;
identifying attributes of the new product;
identifying replacement items for the new product; and
comparing the attributes of the new product to the attributes of the previously sold items, and the replacement items within the sales category, to yield the similarity measurement;
based on the similarity measurement, making a data request to a historical sales database for sales information associated with the previously sold items;
receiving the sales information associated with the previously sold items from the historical sales database;
retrieving, from a database, a first version of a machine learning forecast;
calculating, based on the sales information and the similarity measurement, a predicted demand for the new product, wherein the calculating of the predicted demand comprises:
entering inputs into the first version of the machine learning forecast, the inputs comprising the sales information and the similarity measurement; and
receiving from the first version of the machine learning forecast, the predicted demand, wherein the first version of the machine learning forecast uses a weighted calculation of the sales information and the similarity measurement to generate the predicted demand;
receiving a supply availability of the new product;
generating an inventory distribution schedule of the new product for the plurality of retail stores based on the supply availability and the predicted demand;
recording actual sales data in the historical sales database; and
generating an updated version of the machine learning forecast based on the actual sales data.

10. The system of claim 9, wherein the attributes comprise:
a shape, a color, a weight, a brand, an amount, and a quality.

11. The system of claim 10, wherein the attributes are identified, at least in part, using a three-dimensional model of the new product.

12. The system of claim 9, the computer-readable storage medium having additional instruction stored which, when executed by the processor, cause the processor to perform operations comprising:
retrieving, from a database, a first version of a machine learning forecast;
entering, as part of the calculating of the predicted demand, inputs into the first version of the machine learning forecast, the inputs comprising the sales information and the similarity measurement
receiving, as part of the calculating of the predicted demand, from the first version of the machine learning forecast, the predicted demand, wherein the first version of the machine learning forecast uses a weighted calculation of the sales information and the similarity measurement to generate the predicted demand;
receiving actual sales data associated with the new product;
recording the actual sales data in the historical sales database; and
generating an updated version of the machine learning forecast based on the actual sales data.

13. The system of claim 12, wherein the inputs into the first version of the machine learning forecast further comprise promotions and calendar events.

14. The system of claim 9, generating a distribution center inventory distribution schedule of the new product for distribution centers which service the plurality of retail stores, the distribution center inventory distribution schedule being based on the supply availability and the predicted demand.

15. The system of claim 14, wherein the inventory distribution schedule and the distribution center inventory distribution schedule are further based on current inventory levels of the replacement items for the new product within the plurality of retail stores and the distribution centers.

16. The system of claim 9, wherein the new product is supplied by a third party e-commerce supplier.

17. A non-transitory computer-readable storage medium having instructions stored which, when executed by a computing device, cause the computing device to perform operations comprising:
receiving instructions to predict demand across a plurality of retail stores for a new product which has not been previously sold within the plurality of retail stores;
generating a similarity measurement between the new product and previously sold items, wherein the similarity measurement compares attributes of the new product to the previously sold items, and wherein the similarity measurement is generated by:
identifying a sales category for the new product;
identifying attributes of the new product;
identifying replacement items for the new product; and
comparing the attributes of the new product to the attributes of the previously sold items, and the replacement items within the sales category, to yield the similarity measurement;
based on the similarity measurement, making a data request to a historical sales database for sales information associated with the previously sold items;
receiving the sales information associated with the previously sold items from the historical sales database;
calculating, based on the sales information and the similarity measurement, a predicted demand for the new product;
receiving a supply availability of the new product; and
generating an inventory distribution schedule of the new product for the plurality of retail stores based on the supply availability and the predicted demand.

18. The non-transitory computer-readable storage medium of claim 17, wherein the attributes comprise:
a shape, a color, a weight, a brand, an amount, and a quality.

19. The non-transitory computer-readable storage medium of claim 18, wherein the attributes are identified, at least in part, using a three-dimensional model of the new product.

20. The non-transitory computer-readable storage medium of claim 17, having additional instructions stored which, when executed by the computing device, cause the computing device to perform operations comprising:
retrieving, from a database, a first version of a machine learning forecast;
entering, as part of the calculating of the predicted demand, inputs into the first version of the machine learning forecast, the inputs comprising the sales information and the similarity measurement
receiving, as part of the calculating of the predicted demand, from the first version of the machine learning forecast, the predicted demand, wherein the first version of the machine learning forecast uses a weighted calculation of the sales information and the similarity measurement to generate the predicted demand;
receiving actual sales data associated with the new product;
recording the actual sales data in the historical sales database; and
generating an updated version of the machine learning forecast based on the actual sales data.
